(19) United States
(12) Patent Application Publication
(10) Pub. No.: US 2004/0124708 A1
(43) Pub. Date: Jul. 1, 2004

(54) Keyless entry system for a vehicle, in particular a motor vehicle

(76) Inventors: Elmar Giehler, Stuttgart-Hausen (DE); Herbert Ott, Rutesheim (DE); Oliver Keil, Gotha (DE); Walter Strohbeck, Narre Warren (AU)

Correspondence Address: KENYON & KENYON, ONE BROADWAY, NEW YORK, NY, 10004, US

(21) Appl. No.: 10/656,082

(22) Filed: Sep. 4, 2003

(30) Foreign Application Priority Data
Sep. 4, 2002 (DE) 102 40 829.7

(51) Int. Cl. B60R 25/04; H01H 47/00

(52) U.S. Cl. 307/10.5

(57) ABSTRACT

A keyless entry system for a vehicle, in particular a motor vehicle, the keyless entry system including a device for unlocking at least one locked door of the vehicle in response to an electronic door opener being manipulated, and the device having at least one input element accessible from the outside of the vehicle. It is provided, that the door of the vehicle may be opened by inputting a code at one or a maximum of two input elements, the code being made up of a sequence of digital or quasi-digital signals, which are generated by alternately manipulating or not manipulating the input element(s).

### BACKGROUND INFORMATION

Electronic door openers for the power locks of motor-vehicle doors, in the form of radio-controlled or infrared-controlled remote controls, are increasingly being used in today's vehicle locking systems. However, they are almost always combined with a mechanical key, by which the vehicle doors can be opened when a battery of the electronic door opener is discharged or the electronic door opener is malfunctioning.

However, the development in the case of motor vehicles is moving in the direction of keyless access systems and/or starting systems (Comfort Entry/Go or Keyless Entry), i.e. systems not having a mechanical key. In these systems, the device for opening the locked doors has, in addition to a passive receiver in the vehicle, an active transmitter in the electronic door opener carried by the driver, the active transmitter communicating with the receiver in the vehicle via UHF, LF, or infrared. This communication normally includes an inquiry protocol, where a code is transmitted by the transmitter to the receiver, and this code is then compared to a stored code in the vehicle in order to check the access authorization of the electronic door opener. The door is unlocked when the transmitted code matches the stored code.

In order to allow user-friendly and rapid access to the vehicle, these keyless entry systems can be equipped with one or two input elements in the form of push-button switches or proximity sensors on the door handle of each vehicle door. When the input elements are manipulated, the receiver in the vehicle is activated and communicates with the transmitter, in order to check the access authorization of the electronic door opener.

In place of the customary ignition lock of mechanical systems, the vehicles equipped with a keyless access and starting system (Comfort Entry/Go) also have a start-stop push-button switch for starting and stopping the vehicle. In response to the start-stop push-button switch being manipulated, the access authorization of the door opener, which is also used here as a non-contact “electronic ignition key”, is queried via a repeated communication between the transmitter and the receiver, before the engine is started.

Using the above-described, keyless access and/or starting systems, the doors of a vehicle can only be unlocked, however, when the electronic door opener is functioning properly, and its battery used as a power supply for the transmitter is charged. But, when the door opener is malfunctioning or its battery is discharged, it is no longer possible to access the vehicle since the necessary communication between its transmitter and the receiver in the vehicle has been interfered with. In contrast to mechanical locking systems, the vehicle can therefore not be opened in spite of valid access authorization, which represents a considerable disadvantage of these electronic locking systems.

A keyless motor-vehicle entry system of the type mentioned at the outset is already known from DE 100 03 608, where an input element in the form of a push-button switch is attached to an outside door handle of the vehicle. Using this input element, the doors of the vehicle can be locked or the windows of the vehicle can be closed as a function of its time of manipulation. In the known system, the doors cannot be unlocked by manipulating the input element, and this would not be practical, since it would allow persons not having access authorization to unlock the doors of the vehicle.

### SUMMARY OF THE INVENTION

The keyless entry system of the present invention has the advantage over the background art that, without the installation of additional components on the vehicle, persons having access authorization may unlock the doors of the vehicle and start it, even in the case of a malfunction or a discharged battery of the electronic door opener, while access continues to be denied to unauthorized persons. The present invention's widening of the functional scope of the components present allows persons having access authorization to even access the vehicle when the electronic door opener is misplaced, lost, or stolen and therefore improves the convenience of operation in these cases. In this context, the safety from theft is not impaired, since, e.g. in the case of automatic teller machines, it turns out that access to a particular account by inputting a PIN code or the like offers, as a rule, sufficient safety from manipulation, and therefore, access to a particular motor vehicle by inputting a vehicle-specific code should be correspondingly safe.

A sequence of digital or quasi-digital signals generated by alternately manipulating or not manipulating the input element(s) is understood as a sequence of individual signals, which each have one of two different, possible states, “zero” or “one”, “on” or “off”, or “high” or “low”, individual letters and/or numerals of the code each being made up of a plurality of consecutive, individual signals, whose varying composition and/or length decides the specific meaning. In the case of the input element being manipulated or not being manipulated, it differentiates between the two input states mentioned and generates corresponding high-level and low-level voltage signals. These are compared to a correspondingly constructed signal sequence of a stored, emergency unlocking code, in which case a match results in the door being unlocked, whereas a deviation results in the door remaining locked.

In order to further improve the operating convenience, a preferred refinement of the present invention provides for the code to be modifiable, so that the owner of the vehicle may select and set a code preferred by him.

The emergency unlocking code may be a letter code, a numeral code, or a combined letter and numeric code, whose letters and/or numerals are made up of individual, digital or quasi-digital signals.

In the case of vehicles equipped with a keyless access and starting system (Comfort Entry/Go), a further preferred refinement of the present invention not only allows the doors to be unlocked but also allows the vehicle to be started, by inputting the digital or quasi-digital code at the input element(s), when the start-stop tip switch is operated within a predefined period of time after the input.

When the locking system of the vehicle includes a single input element used in combination with the electronic door opener for both unlocking and locking the doors, a further preferred refinement of the present invention provides for the locking system to include an optical and/or, in some instances, an acoustic indicator as a user prompt, which displays to the user the specific operating state of the locking system and/or a beginning or an end of a maximum available time span for inputting the code and/or the opening of the locked door after entry of the code. An optical display element in the form of a light-emitting diode (LED) is advantageously used on or near a door button of the driver-side door. In most passenger cars having conventional locking systems, this light-emitting diode is already standard for indicating the activation of an alarm system or anti-theft system of the vehicle. The flashing frequency of this light-emitting diode may be variable, in order for its change to indicate a change in the operating state of the locking system, and the flashing frequency may also be advantageously used to indicate to the user the correct frequency for inputting the signals of the emergency unlocking code.

The input element may be a tip switch, a proximity switch, or a sensor, which functions in response to being touched or approached by a finger of the user or another object and is preferably situated on a door handle of a vehicle door, so that the light-emitting diode installed on or near the door knob and used as an indicator is in the field of view of the user during the input.

When the locking system of the vehicle includes two input elements, of which one is used to unlock the door and one is used to lock the door, the prompting of the user with the aid of an optical or acoustic display element may be dispensed with, in that both input elements are alternately used for inputting the code, e.g. one for inputting signals whose number corresponds to a code numeral to be input, and the other for inputting a signal which indicates an end of the input of a numeral and a beginning of the input of the next numeral.

### BRIEF DESCRIPTION OF THE DRAWINGS

FIG. 1 shows a side view of a passenger car having a locking system of the present invention.

FIG. 2 shows a top view of a part of a passenger-car door, having an input element in the form of a tactile switch on the inside of the door handle.

FIG. 3 shows a time sequence chart for the input of an exemplary letter code at the input element.

FIG. 4 shows a segment of a time sequence chart for inputting an exemplary numeric code at the input element.

FIG. 5 shows a segment of a time sequence chart for inputting the exemplary numeric code in another manner.

FIG. 6 shows a view corresponding to FIG. 2, but the door handle being provided with two input elements.

FIG. 7 shows a segment of a time sequence diagram for inputting the exemplary numerical code from FIG. 4 at the two input elements of the door handle from FIG. 6.

### DETAILED DESCRIPTION

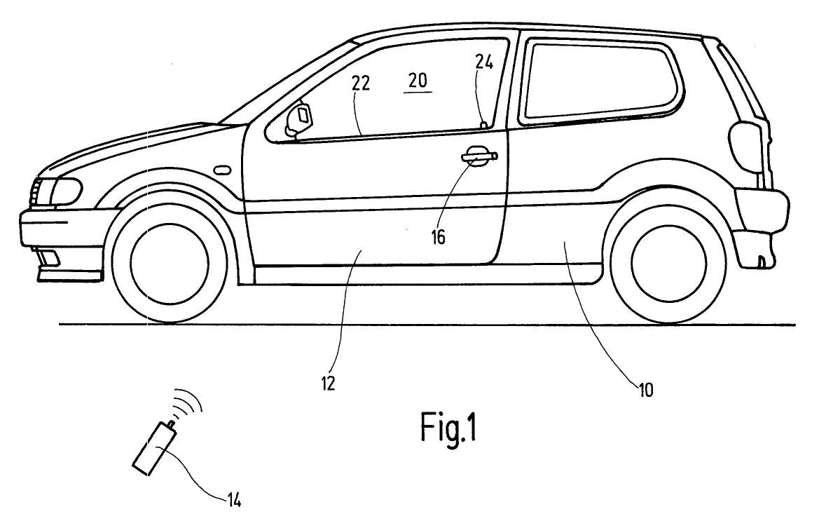

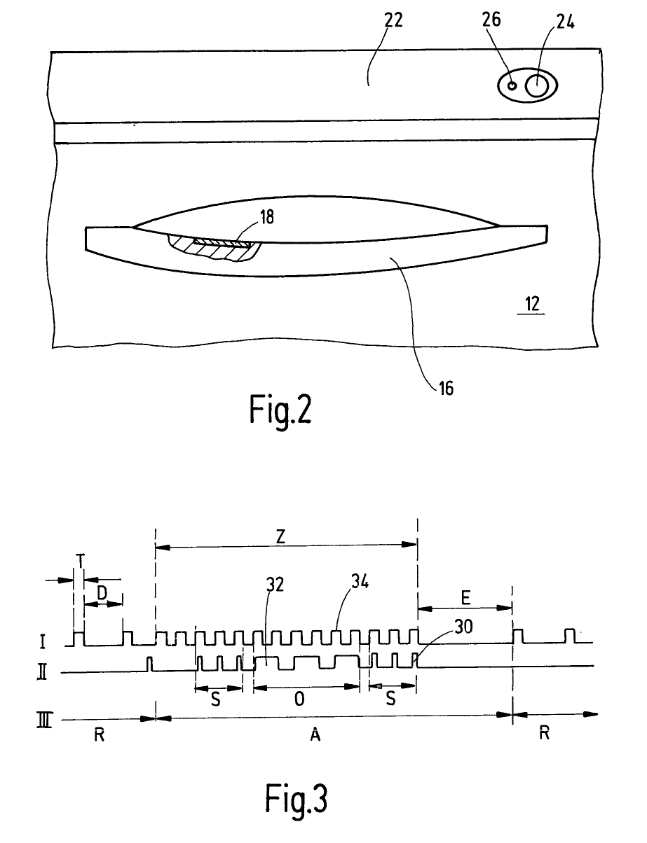

Passenger car 10 represented in FIG. 1 and 2 is equipped with a keyless entry system of the present invention in the form of a central locking system. As in the case of known central locking systems, this central locking system includes a motor-operated locking device (not shown), which is at each door 12 of passenger car 10, and with the aid of which door 12 may be locked or unlocked again by properly manipulating an electronic door opener 14. In addition, this central locking system includes an input element, which is in the form of a tactile switch 18 and attached to door handle 16 of each door 12.

Door opener 14 carried by a user, usually the driver of the passenger car, includes a battery-operated transmitter, which communicates, via a UHF or LF antenna 15, with a receiver in a power-lock control system inside the vehicle (not shown), prior to unlocking doors 12 of passenger car 10, in order to allow the control system to check the access authorization of the door opener by comparing an access code transmitted by the transmitter to the receiver to a code stored in the control system. When doors 12 are locked, the connection between the transmitter of door opener 14 and the receiver of the central locking system is automatically established, as soon as the user touches tactile switch 18 on one of doors 12 and therefore expresses his desire to unlock doors 12.

In conventional locking systems, the locking state of doors 12 is indicated by a door button 24, which is attached to window parapet 22 near the inside of a window pane 20 of doors 12, and is retracted when door 12 is locked and extended when door 12 is unlocked. As in many conventional locking systems, a light-emitting diode 26 (FIG. 2) situated on window parapet 22 near door button 24 shows the proper functioning of an alarm system or anti-theft system of passenger car 10 by blinking when doors 12 are locked.

Since doors 12 may no longer be unlocked by door opener 14, when it is malfunctioning or the door-opener battery is discharged, since, in this case, door opener 14 does not react to the access-authorization code inquiry by the power-lock control system, the locking system is additionally provided with an emergency unlocking system, which allows the user to unlock one or all doors 12 of passenger car 10 by inputting an emergency unlocking code previously entered into the power-lock control system, at tactile switch 18 of driver-side door 12 or, optionally, of another door.

Tactile switch 18 has two output states “on” and “off”, of which the first is activated when switch 18 is touched, while the second is always activated when switch 20 is not touched at that very moment. The two output states of switch 18 are read off and transmitted by cable to the control system of the power door locks. Therefore, the emergency unlocking code may be generated and transmitted to the power-lock control system, by intermittently touching tactile switch 18 in a particular contact pattern, in order to compare the emergency unlocking code, there, to a stored, emergency unlocking code and unlock the door or doors 12 when they match.

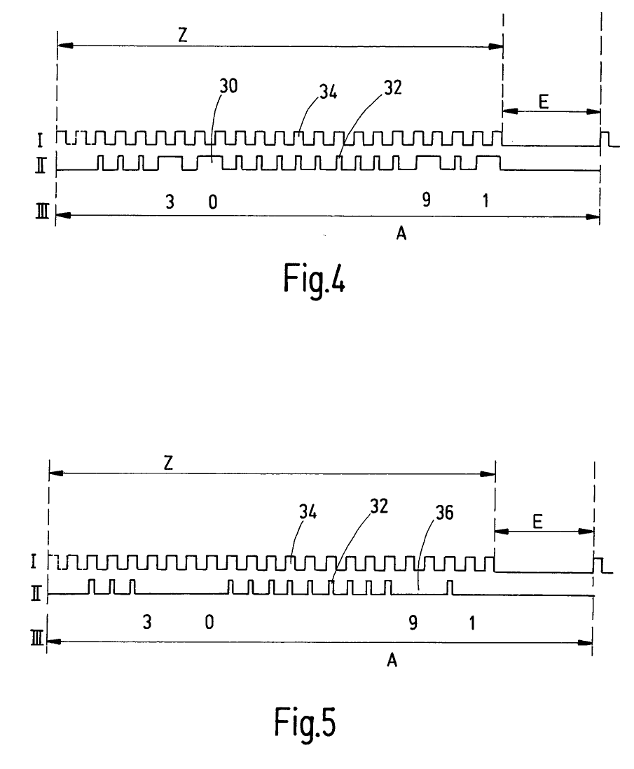

In principle, both an alphabetical code and a numeric code may be used. In the case first mentioned, and in the case represented in FIG. 3, each letter of the code is assigned a sequence of several short and long signals 30 and 32, respectively, having a different order. For example, the signal sequences of the Morse alphabet may be selected as signal sequences, in which an alphabetical code S O S used as an example is made up of the signal sequence three short, three long, and three short, the selected signal sequence being producible by intermittently touching tactile switch 18 and maintaining the contact for a shorter or longer time interval. In the case last mentioned, and in the case represented in FIG. 4, each numeral from 0 to 9 is assigned a corresponding number of shorter signals 30, while longer signals 32 indicate the end of a numeral or the beginning of the next numeral.

The rate at which tactile switch 18 must be manipulated during the entry of the code is determined by the flashing sequence of light-emitting diode 26 indicated in FIGS. 3, 4, and 5 by a line referred to as I, while line II indicates the signal sequence input at tactile switch 18, and line III indicates the operating state of the emergency unlocking system, using the three phases, rest state R, activation state A, and new rest state R.

In rest state R of the emergency unlocking system, light-emitting diode 26 flashes at a flashing frequency of 0.2 Hz in the exemplary embodiments in FIGS. 3, 4, and 5, interval D between the end of a light pulse and the beginning of the next light pulse being 4.5 s. In each operating state, duration T of the light pulses is always 0.5 s.

In each case of tactile switch 18 being operated for the first time, the emergency unlocking system is activated over a maximum period of time Z of, e.g. 30 seconds, which is indicated by a more rapid flashing sequence of the light emitting diode, e.g. 1 Hz. The entry of the code, which must be completed within period of time Z may be begun as soon as light-emitting diode 26 flashes at this frequency.

In order to input a shorter signal 30, such as one of the three signals of the letter S of letter code S O S in FIG. 3 or one of the nine signals of the numeral 9 of the four-digit numeric code 3091 in FIG. 4, tactile switch 18 is briefly manipulated during a flash signal 34 of light-emitting diode 26, which corresponds to a manipulation time of approximately 0.2 to 0.5 s. In order to input a longer signal 32, such as one of the three signals of the letter O of letter code S O S in FIG. 3 or an interrupt signal between the end of the input of a numeral and the beginning of the input of the next numeral of the numeral code 3091 in FIG. 4, tactile switch 18 is touched in response to a flash signal 34, and the contact is maintained until next flash signal 34, which corresponds to a manipulation time of approximately 1 to 1.2 s. The two manipulation times differ markedly from one another and therefore allow signals 30, 32 to be clearly evaluated in the control system of the power door locks.

In the exemplary embodiment in FIG. 5, the end of the input of a numeral and the beginning of the input of the next numeral is not indicated by a longer manipulation of tactile switch 18, as in FIG. 4, but rather by a gap 36, in that, in each case, tactile switch 18 is not manipulated during two flash pulses 34 of light-emitting diode 26. As an alternative, each gap 36 may have a length of only one flash pulse.

In the event of an input error, tactile switch 18 is held three seconds long, in order to abort the input and reactivate the emergency unlocking system (not shown).

When the entry of the emergency unlocking code is successful, i.e. when a comparison to the stored, emergency unlocking code in the power-lock control system resulted in a match, doors 12 are unlocked by the central locking system, and the flashing of light-emitting diode 26 is interrupted during a time interval E of approximately 5 seconds.

Passenger car 10 may be started once within a predefined period of time after the successful input, i.e. after the unlocking of doors 12 by successfully inputting the emergency unlocking code at tactile switch 18, without a further check of the access authorization.

When the emergency unlocking code is incorrectly entered several times, e.g. three times, then, for safety reasons, the power-lock control system blocks doors 12 from being unlocked by the emergency unlocking code, so that access to the vehicle is only still possible with the aid of functioning, electronic door opener 12. After doors 12 are unlocked by door opener 12, a fault storage means in the control system is automatically reset to zero.

The emergency unlocking code, which is stored in the power-lock control system, and to which the code input at tactile switch 18 is compared, is advantageously set in the factory and stored in the vehicle documents, so that the user is able to look it up. If necessary, this code may be changed, e.g. if it is not easily remembered by the user, or by the new owner of passenger car 10 after being sold, in order to prevent the previous owner from being granted access to passenger car 10 via the emergency unlocking system. To this end, in the case of a functioning door opener 14, the old code is first entered at tactile switch 18, and the new code is then entered twice for safety reasons, once for inputting it into the memory of the control system and once for confirming this input.

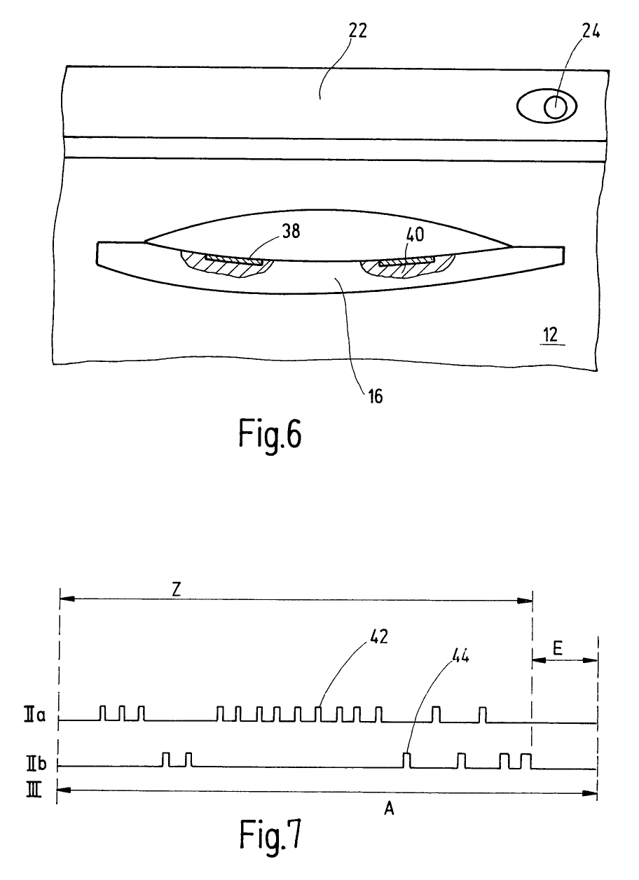

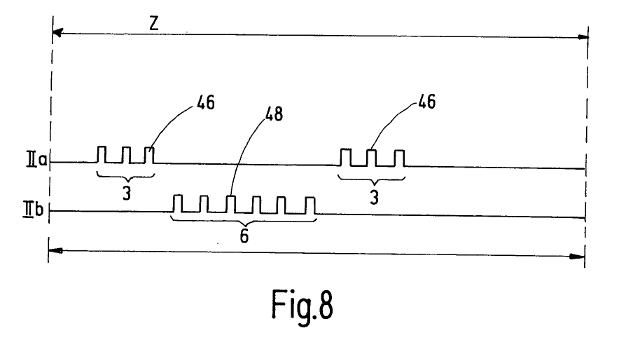

FIGS. 6 and 7 show another exemplary embodiment, in which two tactile switches 38, 40 are spaced apart from each other on the inside of door handle 16. In contrast to the previous exemplary embodiments, in which both the unlocking and the locking of doors 12 were initiated by tactile switch 18, in this case, one tactile switch 38 or 40 must be manipulated to unlock doors 12, while other switch 40 or 38 must be manipulated to lock doors 12.

For unlocking in the case of an emergency, one of two switches 38 is used to input the numerals (line IIa) that are made up of a number of signals 42 corresponding to the numeral, while the other is used to signal the end of the input of a numeral and the beginning of the input of the next numeral, or the end of the input routine, using a single signal 44 (line IIb). Optical operational guidance by light-emitting diode 26 may then be dispensed with.

In addition, proximity switches or other sensors, such as photoelectric readers or the like, may be provided in place of tactile switch(es) 18, 38, 40.

What is claimed is:

1. A keyless entry system for a motor vehicle, comprising:
a device for unlocking at least one locked door of the vehicle in response to manipulation of an electronic door opener, the device having at least one input element accessible from outside of the vehicle, wherein the door may be unlocked by inputting a code at the input element, the code including a sequence of digital or quasi-digital signals, the signals being generated by alternately manipulating or not manipulating the input element.

2. The keyless entry system as recited in claim 1, wherein the code may be changed.

3. The keyless entry system as recited in claim 1, wherein the vehicle may be started only after the code is input at the input element.

4. The keyless entry system as recited in claim 3, wherein it is possible to start the vehicle only during a predefined, limited time span after the code is input.

5. The keyless entry system as recited in claim 1, wherein the input element is configured to differentiate between two input states and to transmit a digital, high-level or low-level voltage signal to the device for unlocking the vehicle door as a function of the input states.

6. The keyless entry system as recited in claim 1, further comprising:
at least one of an optical and an acoustic indicator configured to indicate at least one of: i) an operating state of the system, ii) a beginning or an end of a maximum available time span for inputting the code, and iii) an ensuing unlocking of the door after the code is input.

7. The keyless entry system as recited in claim 6, wherein the at least one of the optical and acoustic indicator is configured to intermittently provide an indication, an indicating frequency of the indication changing as a function of an operating state of the system.

8. The keyless entry system as recited in claim 6, wherein the at least one of the optical and acoustic indicator is configured to intermittently provide an indication, an indicating frequency of the indication showing a user a frequency for inputting the signals of the code.

9. The keyless entry system as recited in claim 6, wherein the indicator is a flashing light source.

10. The keyless entry system as recited in claim 9, wherein the light source is a light-emitting diode installed on or near a door button of a door of the vehicle.

11. The keyless entry system as recited in claim 1, wherein, after an incorrect code is input several times within a predefined period of time, the locked vehicle door may be opened only by manipulating a functioning electronic door opener.

12. The keyless entry system as recited in claim 11, further comprising:
a fault storage device, wherein, in response to the vehicle door being opened by the functioning electronic door opener, the fault storage device is reset for opening the locked vehicle door.

13. The keyless entry system as recited in claim 1, wherein the input element is one of a tactile switch or a proximity switch.

14. The keyless entry system as recited in claim 1, wherein the input element is situated on a door handle of a door of the vehicle.

15. A motor vehicle, comprising:
a keyless entry system including a device for unlocking at least one locked door of the vehicle in response to manipulation of an electronic door opener, the device having at least one input element accessible from outside of the vehicle, wherein the door may be unlocked by inputting a code at the input element, the code including a sequence of digital or quasi-digital signals, which are generated by alternately manipulating or not manipulating the input element.
